(19) United States
(12) Patent Application Publication
(10) Pub. No.: US 2018/0027776 A1
(43) Pub. Date: Feb. 1, 2018

(54) Pet buckle

(71) Applicant: Silong CHEN, Guangdong (CN)

(72) Inventor: Silong CHEN, Guangdong (CN)

(21) Appl. No.: 15/649,631

(22) Filed: Jul. 13, 2017

(30) Foreign Application Priority Data
Jul. 27, 2016 (CN) 201610600528.1

(51) Int. Cl. A01K 27/00; A44B 13/00; A44B 13/02

(52) U.S. Cl. CPC A01K 27/005; A44B 13/02; A44B 13/0029

(57) ABSTRACT

A pet buckle includes a hook-shaped buckle body, and a lock rod openable with respect thereto; the buckle body having an end portion and a front end, with an opening formed those two; the lock rod including a first end hinged to the buckle body through a first rotation shaft, and a second end locked with the front end, a middle part thereof sheathed by a torsional spring, to enclose the opening of the buckle body; the end portion including a first and a second anti-trip clips, with the first one fixed to both ends of the first rotation shaft; the second clip fixed to both ends of the second rotation shaft; a stepped portion and an anti-trip portion engaged with each other formed on the inside of the two clips respectively. With the clips, the lock rod cannot rotate to open the pet buckle occasionally, thereby improving the reliability.

### BACKGROUND OF THE INVENTION

The present disclosure relates to a fastener, specifically to a pet buckle.

With the development of China's social economy, people's quality of life has also been improved, raising family pets—such as pet dog, and pet cat, has become a new way of people's pastime recreation. In raising pets, it is often needed to take pets out for outdoor activities so as to meet the pet's activity demands, and meanwhile to cultivate feelings between people and pets. During the pet outdoor activities, a pet buckle is needed to connect the rope and the pet collar, so that the motion range of pets can be controlled. The present pet buckle cannot achieve a reliable connection, and is easy to get accidentally opened, then during the usage of pet buckle, it is easy to happen that the pet collar and rope get separated because of pet traction, and thus people cannot control the pet's motion range, which may possibly cause pet loss or pet disturbances and other unexpected problem.

Thus the present technology need to be improved and optimized.

### BRIEF SUMMARY OF THE INVENTION

In view of the above deficiencies of the prior art, it is an object of the present disclosure to provide a pet buckle, which can improve the pet buckle's locking reliability.

In order to achieve the above object, an embodiment of the present disclosure provides solution as follows.

A pet buckle is disclosed, including a hook-shaped buckle body, and a lock rod which can be opened and closed with respect to the hook-shaped buckle body; the hook-shaped buckle body having an end portion on which a connection groove is formed and a front end away from the end portion, with an opening formed by the end portion and the front end; the lock rod comprising a first end located in the connection groove and hinged to the hook-shaped buckle body through a first rotation shaft, and a second end away from the first end and locked with the front end of the hook-shaped buckle body, a middle part of the lock rod sheathed by a torsional spring, so as to enclose the opening of the hook-shaped buckle body; wherein, the end portion of the hook-shaped buckle body is further provided with a first anti-trip clip and a second anti-trip clip, and the first anti-trip clip is fixed to both ends of the first rotation shaft; the end portion of the hook-shaped buckle body is also provided with a second rotation shaft, and the second anti-trip clip is fixed to both ends of the second rotation shaft; a stepped portion is formed on the inside of the first anti-trip clip, while an anti-trip portion engaged with the stepped portion is accordingly formed on the inside of the second anti-trip clip.

In a further embodiment, an end of the second anti-trip clip is spaced apart from the end portion of the hook-shaped buckle body by a predetermined distance.

In a further embodiment, the second end of the lock rod is provided with a first groove and a first protrusion, and the front end of the hook-shaped buckle body is provided with second projection fitted to the first groove and a second recess fitted to the first projection.

In a further embodiment, the pet buckle further comprising link ring with a through hole, a connecting shaft is provided at bottom of the hook-shaped buckle body, a boss is formed on an end of the connecting shaft, and the link ring is hung on the connecting shaft through the through hole.

In a further embodiment, the connecting shaft has a diameter smaller than a diameter of the through hole.

In a further embodiment, the pet buckle is in a “B” shape.

Compared with the prior art, the pet buckle in the present disclosure including a hook-shaped buckle body, and a lock rod which can be opened and closed with respect to the hook-shaped buckle body; the hook-shaped buckle body having an end portion on which a connection groove is formed and a front end away from the end portion, and an opening formed by the end portion and the front end; the lock rod comprising a first end located in the connection groove and hinged to the hook-shaped buckle body through a first rotation shaft, and a second end away from the first end and locked with the front end of the hook-shaped buckle body, so as to enclose the opening of the hook-shaped buckle body; wherein, the end portion of the hook-shaped buckle body further provided with a first anti-trip clip and a second anti-trip clip, and the first anti-trip clip is fixed to both ends of the first rotation shaft; the end portion of the hook-shaped buckle body is also provided with a second rotation shaft, and the second anti-trip clip is fixed to both ends of the second rotation shaft; a stepped portion is formed on the inside of the first anti-trip clip, while an anti-trip portion engaged with the stepped portion is accordingly formed on the inside of the second anti-trip clip. With the first anti-trip clip and the second anti-trip clip formed at the end portion of the hook-shaped buckle body, when the pet buckle in the disclosure is locked, the stepped portion of the first anti-trip clip gets engaged and fixed with the anti-trip portion of the second anti-trip clip, so that the lock rod cannot rotate to open the pet buckle, thereby improving the reliability of the pet buckle.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure.

FIG. 1 is an illustrative structural view of a lock rod at a locking state in accordance with an exemplary embodiment of the present invention.

FIG. 2 is an illustrative view of a lock rod at an openable state in accordance with the exemplary embodiment of the present invention.

FIG. 3 is an enlarged view of part P in FIG. 2.

### DETAILED DESCRIPTION OF THE INVENTION

A pet buckle is disclosed herein, for the purpose of further understanding the object, technical solution and effect of the present disclosure. The present disclosure will hereinafter be described in detail with reference to an exemplary embodiment. It should be understood that the specific embodiments described herein are merely illustrative example of the invention and are not intended to limit the invention.

The pet buckle provided by the disclosure is mainly used by matching with a pet collar, when the pet buckle is open and the collar is released, the pet may move freely, and the pet can only move under the traction of the owner when the pet buckle locks the pet collar.

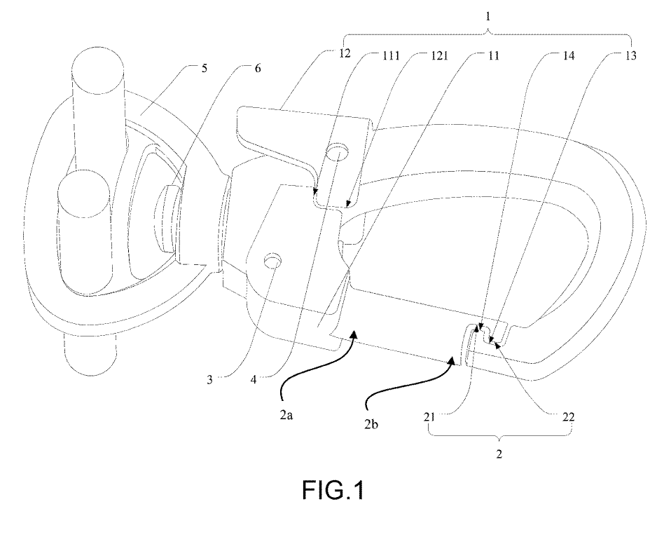

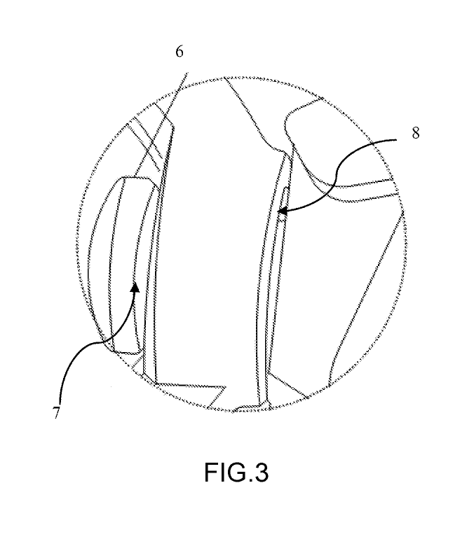

Referring to FIGS. 1-3, the present disclosure provides a pet buckle, including a hook-shaped buckle body 1 and a lock rod 2 which can be opened and closed with respect to the hook-shaped buckle body 1. The hook-shaped buckle body 1 includes an end portion provided with a connection groove (not shown), and a front end away from the end portion, with an opening 10 formed by the end portion and the front end, and the lock rod 2 includes a first end 2a located in the connection groove and hinged to the hook-shaped buckle body 1 through a first rotation shaft 3, and a second end 2b away from the first end 2a. A middle part of the lock rod 2 is sheathed by a torsional spring (not shown), so that the lock rod 2 can only rotate toward the inside of the hook-shaped buckle body 1, the second end of the lock rod 2 can be locked to the front end of the hook-shaped buckle body 1, and the opening 10 of hook-shaped buckle body 1 thus gets enclosed, and therefore the pet collar can be locked.

In the present embodiment, the end portion of the hook-shaped buckle body 1 is further provided with a first anti-trip clip 11 and a second anti-trip clip 12, the first anti-trip clip 11 is fixed to both ends of the first rotation shaft 3 to rotate synchronously along with the first rotation shaft 3. The end portion of the hook-shaped buckle body 1 is also provided with a second rotation shaft 4, and the second anti-trip clip 12 is fixed to both ends of the second rotation shaft 4 to rotate synchronously along with the second rotation shaft 4. Herein the first anti-trip 11 and the second anti-trip 12 are respectively located on two sides of the end portion of the hook-shaped buckle body 1, and a stepped portion 111 is formed on the inside of the first anti-trip clip 11, while an anti-trip portion 121 engaged with the stepped portion 111 is accordingly formed on the inside of the second anti-trip clip 12. The end portion of the second anti-trip clip 12 is spaced apart from the end portion of the hook-shaped buckle body 1 by a predetermined distance, so that the second anti-trip clip 12 may rotate within a preset angle range.

In the present disclosure, with the first anti-trip clip 11 and the second anti-trip clip 12 provided at the end portion of the hook-shaped buckle body 1, when the pet buckle is locked, the stepped portion 111 of the first anti-trip clip 11 engaged and fixed with the anti-trip portion 121 of the second anti-trip clip 12, so that the lock rod 2 cannot rotate to open the pet buckle, thereby improving the reliability of the pet buckle. During unlocking the buckle, it is only needed to simply press the end portion of the second anti-trip clip 12 to drive the second anti-trip clip 12 to rotate outward, to release the stepped portion 111, and the lock rod 2 can then be pressed to move towards the inside of the hook-shaped buckle body 1, thus further to release the pet collar. When the pet buckle is being locked, after the lock rod is reset, the anti-trip portion 121 gets rotated towards the inside of the hook-shaped buckle body 1, so that the anti-trip portion 121 gets engaged with the step portion 111, to realize a function of preventing occasionally unlocking.

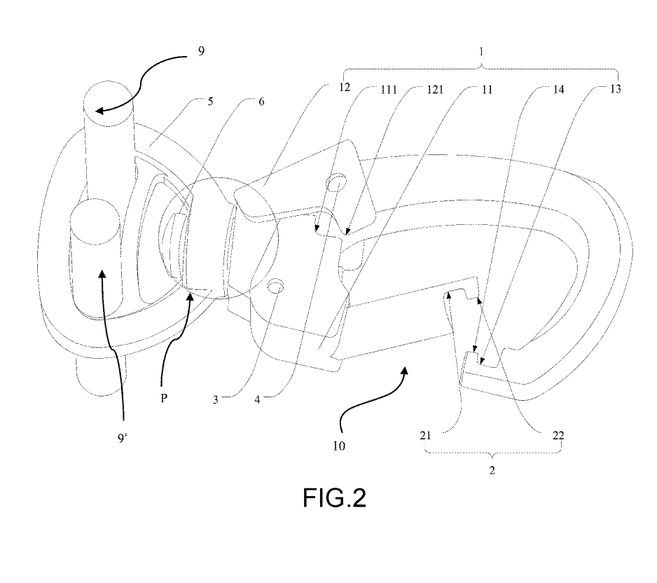

Still referring to FIGS. 1 and 2, in the pet buckle of the present disclosure, the second end of the lock rod 2 is provided with a first groove 21 and a first projection 22, and the front end of the hook-shaped buckle body 1 is provided with a second projection 14 fitted to the first groove 21 and a second recess 13 fitted to the first projection 22. When the pet buckle is being locking, the first recess 21 engages with the second projection 14, and the first protrusion 22 engages with the second recess 13, to prevent the lock rod 2 from rotating toward the outside of the hook-shaped buckle body 1.

Further, the pet buckle of the present disclosure further includes a link ring 5, the link ring 5 is provided with a through hole 8, the bottom of the hook-shaped buckle body 1 is provided with a connecting shaft 7, and a boss 6 is formed on an end of the connecting shaft 7. The link ring 5 is hung on the connecting shaft 7 through the through hole 8 and is located between the boss 6 and the end of the connecting shaft 7. In the present embodiment, the diameter of the connecting shaft 7 is smaller than the diameter of the through hole 8, so that the connecting shaft 7 can freely rotate in the through hole 8, thereby improving the comfort and avoiding the twisting of the traction rope, when pulling the pet.

Furthermore, the link ring 5 is in a “B” shape in such a manner that the traction rope 9 and the belt 9′can be locked on the link ring 5.

As described above, according to the present disclosure, with the first anti-trip clip and the second anti-trip clip formed at the end portion of the hook-shaped buckle body, when the pet buckle is locked, the stepped portion of the first anti-trip clip gets engaged and fixed with the anti-trip portion of the second anti-trip clip, so that the lock rod cannot rotate to open the pet buckle, thereby improving the reliability of the pet buckle. During unlocking the buckle, it is only needed to simply press the end portion of the second anti-trip clip to drive the second anti-trip clip to rotate outward, to release the stepped portion, and the lock rod can then be pressed to move towards the inside of the hook-shaped buckle body 1, thus further to release the pet collar. When the pet buckle is being locked, after the lock rod is reset, the anti-trip portion gets rotated towards the inside of the hook-shaped buckle body, so that the anti-trip portion gets engaged with the step portion, to realize a function of preventing occasionally unlocking. In addition, the present invention involves advantages of a simple structure and convenient operation.

It is to be understood by those skilled in the art that many equivalents or variations may be made in accordance with the technical solutions of the invention and the inventive concept thereof, and all such equivalents or variations should be within the scope of the claims appended hereto.

What is claimed is:

1. A pet buckle, comprising a hook-shaped buckle body, and a lock rod which can be opened and closed with respect to the hook-shaped buckle body;
the hook-shaped buckle body having an end portion on which a connection groove is formed and a front end away from the end portion, with an opening formed by the end portion and the front end;
the lock rod comprising a first end located in the connection groove and hinged to the hook-shaped buckle body through a first rotation shaft, and a second end away from the first end and locked with the front end of the hook-shaped buckle body, a middle part of the lock rod sheathed by a torsional spring, so as to enclose the opening of the hook-shaped buckle body; wherein,
the end portion of the hook-shaped buckle body is further provided with a first anti-trip clip and a second anti-trip clip, and the first anti-trip clip is fixed to both ends of the first rotation shaft;
the end portion of the hook-shaped buckle body is also provided with a second rotation shaft, and the second anti-trip clip is fixed to both ends of the second rotation shaft;
a stepped portion is formed on the inside of the first anti-trip clip, while an anti-trip portion engaged with the stepped portion is accordingly formed on the inside of the second anti-trip clip.

2. The pet buckle as describe in claim 1, wherein an end of the second anti-trip clip is spaced apart from the end portion of the hook-shaped buckle body by a predetermined distance.

3. The pet buckle as describe in claim 1, wherein the second end of the lock rod is provided with a first groove and a first protrusion, and the front end of the hook-shaped buckle body is provided with second projection fitted to the first groove and a second recess fitted to the first projection.

4. The pet buckle as describe in claim 1, wherein the pet buckle further comprising link ring with a through hole, a connecting shaft is provided at bottom of the hook-shaped buckle body, a boss is formed on an end of the connecting shaft, and the link ring is hung on the connecting shaft through the through hole.

5. The pet buckle as describe in claim 4, wherein the connecting shaft has a diameter smaller than a diameter of the through hole.

6. The pet buckle as describe in claim 4, wherein the pet buckle is in a “B” shape.
